(19) United States
(12) Patent Application Publication
(10) Pub. No.: US 2011/0295462 A1
(43) Pub. Date: Dec. 1, 2011

(54) SYSTEM FOR CONTROLLING CLOCK FOR VEHICLE USING GPS INFORMATION

(75) Inventors: Hee Sang Park, Hwaseong-si (KR); Hyun Kim, Hwaseong-si (KR); June Kyu Park, Hwaseong-si (KR); Jung Hwan Yun, Seoul (KR); Hun Soo Kim, Bucheon-si (KR)

(73) Assignee: Hyundai Motor Company, Seoul (KR)

(21) Appl. No.: 12/955,430

(22) Filed: Nov. 29, 2010

(30) Foreign Application Priority Data
May 28, 2010 (KR) 10-2010-0050316

(51) Int. Cl. G06F 7/00

(52) U.S. Cl. 701/36

(57) ABSTRACT

A system for controlling a clock for a vehicle using Global Positioning System (GPS) information, may include a GPS reception unit for receiving the GPS information from satellites, a clock oscillator for measuring a time value by generating clocks, a switch unit for supplying a user-changed time value by manipulation thereof, a display unit for displaying a current time, and a control unit for, when power of the vehicle is applied, displaying the current time to the display unit by outputting a sum of the time value of the clock oscillator and the user-changed time value of the switch unit, and, when invalid information has been received from the GPS reception unit, storing the user-changed time value reset using the switch unit and then outputting the current time.

### CROSS-REFERENCE TO RELATED APPLICATIONS

The present application claims priority to Korean Patent Application No. 10-2010-0050316 filed on May 28, 2010, the entire contents of which is incorporated herein for all purposes by this reference.

### BACKGROUND OF THE INVENTION

1. Field of the Invention

The present invention relates generally to a system for controlling a clock for a vehicle, and, more particularly, to a system for controlling a clock for a vehicle using Global Positioning System (GPS) information, which is capable of reflecting settings based on a user's correction.

2. Description of Related Art

In general, a clock for a vehicle for notifying a driver and/or one or more passengers of the time is installed in a vehicle, and can continuously indicate the time when a driver or a passenger first sets the current time.

Although such a clock for a vehicle retains a set time value using firm power even when the vehicle has been turned off, there is the inconvenience of resetting the current time after the lifetime of a battery has expired and the battery is replaced.

Recently, in order to solve this problem, a GPS terminal is installed and used in conjunction with such a clock for a vehicle so that the clock for a vehicle is provided with GPS signals from satellites. Accordingly, even when power is temporarily cut off, the current time is automatically set using the GPS information.

Meanwhile, the clock for a vehicle using GPS information is problematic because the time is set using only GPS information, so that it is difficult to deal with daylight saving time or it is difficult for a driver or a passenger to freely manipulate the clock for a vehicle, and so it is difficult to accurately indicate the time when unreliable GPS information has been received due to geographical features or for some other reason.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a system for controlling a clock for a vehicle using GPS information in order to prevent the current time from being set using unreliable GPS information.

In an aspect of the present invention, the system for controlling a clock for a vehicle using Global Positioning System (GPS) information, may include a GPS reception unit for receiving the GPS information from satellites, a clock oscillator for measuring a time value by generating clocks, a switch unit for supplying a user-changed time value by manipulation thereof, a display unit for displaying a current time, and a control unit for, when power of the vehicle may be applied, displaying the current time to the display unit by outputting a sum of the time value of the clock oscillator and the user-changed time value of the switch unit, and, when invalid information has been received from the GPS reception unit, storing the user-changed time value reset using the switch unit and then outputting the current time.

When valid information has been received from the GPS reception unit, whether there has been a history of manipulation of the switch unit prior to reception of the GPS information may be determined, and then, when there has been a history of manipulation of the switch unit prior to the reception of the GPS information, the history of manipulation of the switch unit may be deleted, and the user-changed time value may be determined by a difference between a screen-displayed time value and the GPS information and then stored.

When valid information has been received from the GPS reception unit and it may be determined that there has been no history of manipulation of the switch unit prior to reception of the GPS information, the GPS information may be stored as the time value of the clock oscillator when the user-changed time value may be zero, and then the current time may be output.

When the user-changed time value may be not zero, the sum of the time value of the clock oscillator and the user-changed time value which may be not zero may be output as the current time.

When the invalid information has been received from the GPS reception unit and the user-changed time value may be determined zero, the time value displayed on the display unit may be continuously used.

When the invalid information has been received from the GPS reception unit and the user-changed time value may be determined to be not zero, the sum of the changed user-changed time value and the time previously displayed on the display unit may be determined and then displayed as the current time, wherein when the user-changed time value may be stored, the history of the manipulation of the switch unit may be stored.

The user-changed time value may be stored in nonvolatile memory.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a diagram showing the configuration of an exemplary system for controlling a clock for a vehicle using GPS information according to the present invention.

FIG. 2 is a front view showing the front portion of the exemplary system for controlling a clock for a vehicle using GPS information according to the present invention.

FIG. 3 is a flowchart showing the operation of the exemplary system for controlling a clock for a vehicle using GPS information according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

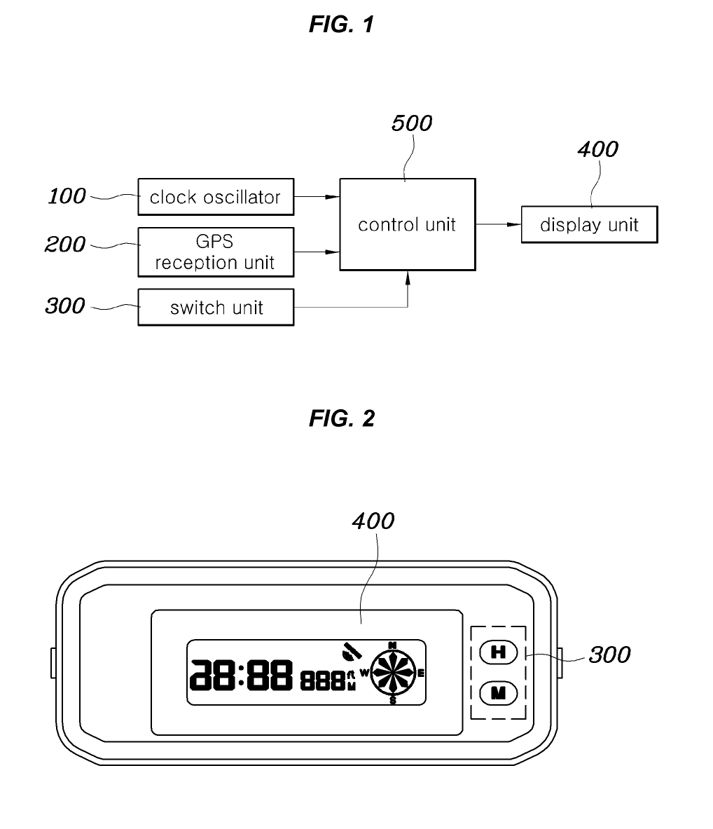

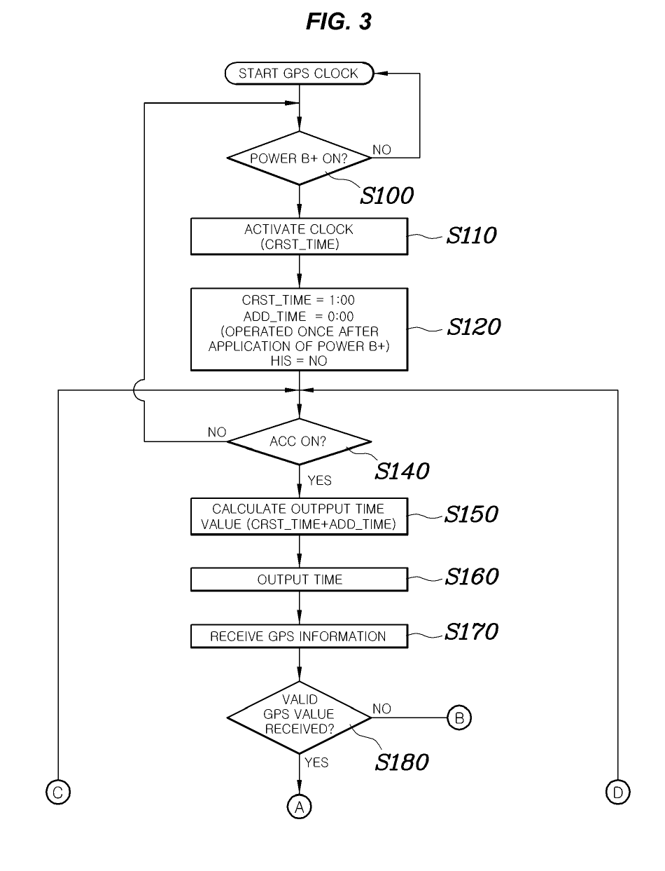

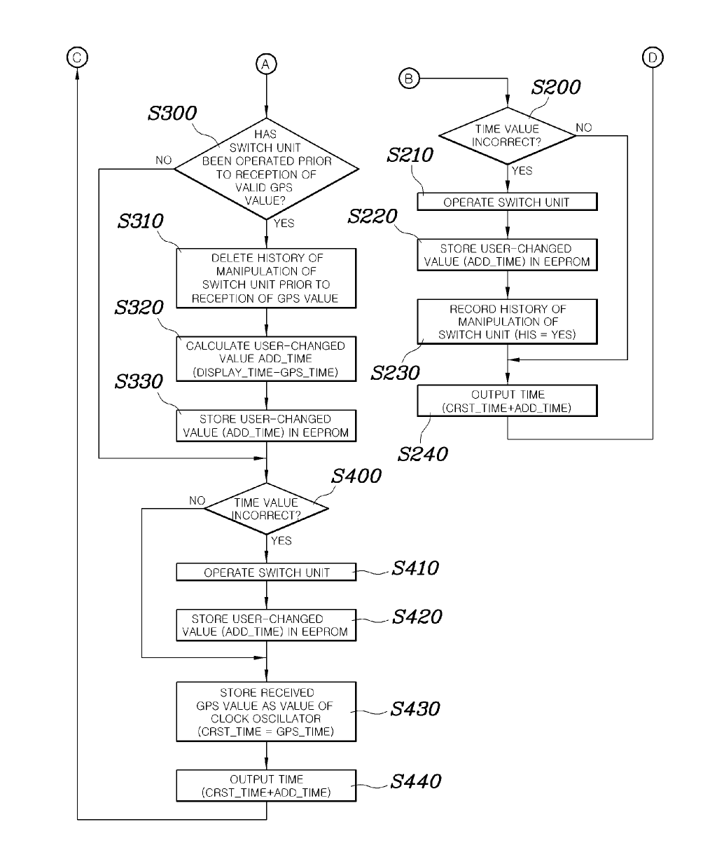

FIG. 1 is a diagram showing the configuration of a system for controlling a clock for a vehicle using GPS information according to an exemplary embodiment of the present invention, FIG. 2 is a front view showing the front portion of the system for controlling a clock for a vehicle using GPS information according to an exemplary embodiment of the present invention, and FIG. 3 is a flowchart showing the operation of the system for controlling a clock for a vehicle using GPS information according to an exemplary embodiment of the present invention.

Referring to FIGS. 1 and 2, the system for controlling a clock for a vehicle using GPS information according to an exemplary embodiment of the present invention includes a GPS reception unit 200, a clock oscillator 100, a switch unit 300 for changing time in response to manipulation by a user, a display unit 400 for displaying the current time, and a control unit 500 for controlling the current time based on the correction conditions of the switch unit 300 depending on whether a GPS signal has been received.

The GPS reception unit 200 receives GPS information, for example, Universal Time Coordinated (UTC), from satellites. For this purpose, the GPS reception unit 200 may be integrated with or separate from the clock for a vehicle using GPS information.

The clock oscillator 100 activates time using a piezoelectric effect. A rubidium oscillator or a crystallized oscillator may be used as the clock oscillator 100. Accordingly, the clock for a vehicle using GPS information enables the clock oscillator 100 itself to generate clocks and then to measure time without requiring GPS signals.

The switch unit 300 is mounted on the front of the clock for a vehicle to facilitate manipulation by a driver or a passenger, and may include two switches to change the hour and the minutes. Accordingly, a driver or a passenger can freely manipulate the time based on information received from the clock oscillator 100 and the GPS reception unit 200.

Information about the manipulation of a driver or a passenger may be stored in separate Electrically Erasable Programmable Read-Only Memory (EEPROM). The number of switches of the switch unit 300 is not limited to two, but may be one or three or more. Furthermore, in so far as changing the hour and the minutes is concerned, the switch unit 300 may be of the touch type, not of the button type.

The control unit 500 enables the current time to be indicated by storing a GPS signal as the time value of the clock oscillator 100 and then outputting the time value if there is no signal indicative of the manipulation of the switch unit 300, because the GPS signal is consistent with the current time. In contrast, if there is a signal indicative of the manipulation of the switch unit 300 because a GPS signal is inconsistent with the current time, the current time is corrected by incorporating the user-set value generated using the switch unit 300 into the current time.

Here, if there is a user-set value generated by the switch unit 300, the user-set value is changed depending on whether a GPS signal has been received. The user-set value is stored in the separate EEPROM. Accordingly, even when the power is cut off and later supplied again, it is possible to provide an accurate time using the corrected user-set value.

As described above, the corrected time is displayed by the display unit 400. The display unit 400 may be formed of various panels such as an LCD, an LED, and an OLED.

Referring to FIG. 3, the operation of the system for controlling a clock for a vehicle using GPS information according to an exemplary embodiment of the present invention will be described below.

First, when firm power B+ is supplied at step S100, the time CRST_TIME generated by the clock oscillator is activated at step S110. Thereafter, the time CRST_TIME generated by the clock oscillator, the user-set value ADD_TIME generated by the switch unit, and a history of the manipulation of the switch unit 300 are read at step S120.

Here, when firm power B+ is not supplied due to the replacement of a battery or the delivery of a new vehicle and then supplied first, the time CRST_TIME generated by the clock oscillator may be initialized and the history of the manipulation of the switch unit HIS is initialized to ‘NO’ also. In contrast, even when firm power has been cut off and then resupplied, the user-set value ADD_TIME generated by the switch unit is not initialized because it is stored in the nonvolatile memory. Only for new vehicles can the user-set value ADD_TIME generated by the switch unit be initialized.

Thereafter, when accessory power ACC is applied to the clock for a vehicle using GPS information at step S140, the sum of the time generated by the clock oscillator and the user-set value ADD_TIME is calculated at step S150, and the calculated value is output onto the display unit at step S160.

When the time is displayed on the display unit, the GPS reception unit operates and receives GPS information, for example, UTC, from satellites at step S170, and whether the information received using the GPS reception unit is valid is determined at step S180.

If the information received from the GPS reception unit is determined not to be valid, the time displayed prior to the reception of the GPS information is continuously used, and a driver or a passenger determines whether the time is correct and then changes the user-set value ADD_TIME generated by the switch unit at steps S200 and S210. Here, if the user-set value ADD_TIME is ‘0’ because the time is determined to be correct by a driver or a passenger, the time value displayed on the display unit can be continuously used.

In contrast, if the user-set value ADD_TIME is changed because the time is determined to be incorrect by a driver or a passenger, the changed user-set value ADD_TIME is stored in the nonvolatile memory at step S220, and the sum of the changed user-set value ADD_TIME and the time previously displayed on the display unit is calculated and then the current time is accurately displayed on the display unit at step S240. Here, when the user-set value ADD_TIME is stored in the nonvolatile memory, the history of the manipulation of the switch unit HIS is stored as ‘YES’ at step S230.

Thereafter, when the vehicle is switched off and accessory power ACC is applied, the history of the manipulation of the switch unit HIS is checked, the previously recorded user-changed value ADD_TIME is read, and the accurate current time can be displayed on the display unit.

Meanwhile, when a valid value is received through the GPS reception unit, whether the switch unit has been operated prior to the reception of the valid GPS information or not is determined at step S300. When the switch unit is determined to have been operated prior to the reception of the GPS information, the history of the manipulation of the switch unit HIS prior to the reception of the GPS information is deleted at step S310, and the user-changed value ADD_TIME is reset using the switch unit at step S320. Here, the user-changed value may be calculated using the difference between the screen-displayed time DISPLAY_TIME and the GPS information GPS_TIME. When the user-changed value ADD_TIME is determined as described above, the displayed time value is retained by storing the determined user-changed value in the nonvolatile memory at step S330.

If a valid value is received from the GPS reception unit and it is determined that there is no history of the manipulation of the switch unit, whether the time displayed on the display unit is correct is determined at step S400, and the user-set value ADD_TIME is changed by a driver or a passenger.

If the user-set value is ‘0’ because the time displayed on the display unit is determined to be correct, the received GPS information is stored in the clock oscillator at step S430 and then the current time is displayed on the display unit using the stored information at step S440. In contrast, if the user-set value ADD_TIME is changed because the time displayed on the display unit is determined to be incorrect at steps S410 and S420, a new time is set using the changed user-set value ADD_TIME and then the current time is accurately displayed on the display unit.

As described above, the system for controlling a clock for a vehicle using GPS information according to an exemplary embodiment of the present invention exploits the correction condition of the switch unit which varies depending on whether the GPS information has been received and displays the time based on the correction condition, thereby producing the effect of preventing the time from being automatically corrected using unreliable GPS information.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system for controlling a clock for a vehicle using Global Positioning System (GPS) information, comprising:
a GPS reception unit for receiving the GPS information from satellites;
a clock oscillator for measuring a time value by generating clocks;
a switch unit for supplying a user-changed time value by manipulation thereof;
a display unit for displaying a current time; and
a control unit for, when power of the vehicle is applied, displaying the current time to the display unit by outputting a sum of the time value of the clock oscillator and the user-changed time value of the switch unit, and, when invalid information has been received from the GPS reception unit, storing the user-changed time value reset using the switch unit and then outputting the current time.

2. The system as set forth in claim 1, wherein, when valid information has been received from the GPS reception unit, whether there has been a history of manipulation of the switch unit prior to reception of the GPS information is determined, and then, when there has been a history of manipulation of the switch unit prior to the reception of the GPS information, the history of manipulation of the switch unit is deleted, and the user-changed time value is determined by a difference between a screen-displayed time value and the GPS information and then stored.

3. The system as set forth in claim 1, wherein, when valid information has been received from the GPS reception unit and it is determined that there has been no history of manipulation of the switch unit prior to reception of the GPS information, the GPS information is stored as the time value of the clock oscillator when the user-changed time value is zero, and then the current time is output.

4. The system as set forth in claim 3, wherein, when the user-changed time value is not zero, the sum of the time value of the clock oscillator and the user-changed time value which is not zero is output as the current time.

5. The system as set forth in claim 1, wherein, when the invalid information has been received from the GPS reception unit and the user-changed time value is determined zero, the time value displayed on the display unit is continuously used.

6. The system as set forth in claim 1, wherein, when the invalid information has been received from the GPS reception unit and the user-changed time value is determined to be not zero, the sum of the changed user-changed time value and the time previously displayed on the display unit is determined and then displayed as the current time.

7. The system as set forth in claim 6, wherein when the user-changed time value is stored, the history of the manipulation of the switch unit is stored.

8. The system as set forth in claim 1, wherein the user-changed time value is stored in nonvolatile memory.
